(19) United States
(12) Patent Application Publication
(10) Pub. No.: US 2026/0079024 A1
(43) Pub. Date: Mar. 19, 2026

(54) IMPLEMENTING PROVIDER PRIORITIZATION MODELS ACROSS DIFFERENT GEOGRAPHIC LOCATIONS AND INTELLIGENTLY GENERATING TRANSPORTATION MATCHES UTILIZING A REQUESTER SELECTED NETWORK CHARACTERISTICS PRIORITIZATION MODEL

(71) Applicant: Lyft, Inc., San Francisco, CA (US)

(72) Inventors: Ashley Christina Chin, San Francisco, CA (US); Mingja Ingrid Edholm, San Mateo, CA (US); Patrick Allen Hollrah, New York, NY (US); Martina Anne Pillay, Oakland, CA (US); Joseph Michael Ricci, Los Angeles, CA (US); David Halsted Riege, San Francisco, CA (US); Brandon Douglas Souba, San Francisco, CA (US); Wilson James Turner, Dedham, MA (US)

(21) Appl. No.: 19/330,560

(22) Filed: Sep. 16, 2025

Related U.S. Application Data
(60) Provisional application No. 63/695,751, filed on Sep. 17, 2024.

(51) Int. Cl. G01C 21/36

(52) U.S. Cl. CPC G01C 21/3688

(57) ABSTRACT

This disclosure describes one or more embodiments of methods, non-transitory computer-readable media, and systems that utilize computing models to intelligently select between provider prioritization models and match provider devices and requester client devices based on dynamic provider network status characteristics in accordance with a requester selected network characteristics prioritization model. In particular, in one or more embodiments, the disclosed systems determine a provider prioritization model according to one or more factors, such as a geographic location of a requester client device and/or a transportation device. Further, the disclosed systems monitor dynamic provider network status characteristics of provider devices to determine a set of prioritized provider devices to match to requester client devices via transportation requests.

### CROSS-REFERENCE TO RELATED APPLICATIONS

This application claims the benefit of, and priority to, U.S. Provisional Application No. 63/695,751, entitled “IMPLEMENTING PROVIDER PRIORITIZATION MODELS ACROSS DIFFERENT GEOGRAPHIC LOCATIONS AND INTELLIGENTLY GENERATING TRANSPORTATION MATCHES UTILIZING A REQUESTER SELECTED NETWORK CHARACTERISTICS PRIORITIZATION MODEL,” filed Sep. 17, 2024, the contents of which are incorporated by reference herein in their entirety.

### BACKGROUND

Recent years have seen significant developments in on-demand transportation systems that utilize mobile devices to coordinate across computer networks. Indeed, the proliferation of web and mobile applications has enabled requesting devices to utilize on-demand ride sharing systems to identify matches between provider devices and requester client devices and coordinate across computer networks to initiate transportation from one geographic location to another. For instance, conventional transportation network systems can determine geographic locations of provider devices and requester client devices, generate digital matches between provider devices and requester client devices, and further track, analyze, and manage pick-up, transportation, and drop-off routines through digital transmissions across computer networks. Although on-demand transportation matching systems can identify requester client devices, select provider devices, dispatch provider devices, and dynamically match requester client devices and provider devices, such systems suffer from a number of technical problems, particularly in flexibility, efficiency, and precision of implementing computer systems.

These, along with additional problems and issues, exist with conventional transportation network systems.

### SUMMARY

This disclosure describes one or more embodiments of methods, non-transitory computer-readable media, and systems that utilize computing models to intelligently select between provider prioritization models and match provider devices and requester client devices based on dynamic provider network status characteristics in accordance with a requester selected network characteristics prioritization model. In particular, in one or more embodiments, the disclosed systems provide a prioritizing provider matching opt-in element in a user interface of a requester client device to enable the disclosed systems to prioritize dynamic provider network status characteristic driven transportation matches when processing transportation requests. For example, the disclosed systems can determine a provider prioritization model according to the location of a provider device and/or a requester client device. Responsive to determining to provide a requester selected network characteristics prioritization model, the disclosed systems can provide a prioritizing provider matching opt-in element in a user interface of a requester client device. In addition, the disclosed systems can select a set of prioritized provider devices by monitoring dynamic provider network status characteristics, such as risk signals and provider network interactions. Indeed, the disclosed systems can compare the dynamic provider network status characteristics to a plurality of network status thresholds. Moreover, responsive to receiving a transportation request, the disclosed systems can generate a provider transportation match between the requester client device and a prioritized provider device of the set of prioritized provider devices and can transmit navigation instructions to a provider device associated with the prioritized provider.

Additional features and advantages of one or more embodiments of the present disclosure are outlined in the description as follows, and in part will be obvious from the description, or may be learned by the practice of such example embodiments.

### BRIEF DESCRIPTION OF THE DRAWINGS

The detailed description refers to the drawings briefly described below.

FIG. 1 illustrates a block diagram of an environment for implementing a dynamic provider prioritizing system in accordance with one or more embodiments.

FIG. 2 illustrates an example flow diagram for selecting a provider prioritization model in accordance with one or more embodiments.

FIG. 3 illustrates the dynamic provider prioritizing system utilizing a self-executing prioritization model to generate a prioritized transportation match in accordance with one or more embodiments.

FIG. 4 illustrates the dynamic provider prioritizing system utilizing a requester selected network characteristics prioritization model to generate a prioritized transportation match in accordance with one or more embodiments.

FIG. 5 illustrates the dynamic provider prioritizing system utilizing operational continuity thresholds to generate transportation matches in accordance with one or more embodiments.

FIGS. 6A-6E illustrate the dynamic provider prioritizing system generating user interfaces for requester client devices and provider devices in accordance with one or more embodiments.

FIG. 7 illustrates an example series of acts for matching a provider device to a requester client device based on dynamic provider network status characteristics.

FIG. 8 illustrates a block diagram of a computing device for implementing one or more embodiments of the present disclosure.

FIG. 9 illustrates an example environment for a transportation matching system in accordance with one or more embodiments.

### DETAILED DESCRIPTION

This disclosure describes one or more embodiments of a dynamic provider prioritizing system that utilizes computing models to intelligently select between different provider prioritization models across locations of a transportation network and match provider devices with requester client devices based on dynamic provider network status characteristics in accordance with a requester selected network characteristics prioritization model. In particular, in one or more embodiments, the dynamic provider prioritizing system provides user interfaces that allow requester client devices to prioritize transportation matches according to dynamic provider network status characteristics when processing transportation requests. In addition, in one or more embodiments, the dynamic provider prioritizing system provides user interfaces that allow requester client devices to opt in to prioritized transportation matches according to dynamic provider network status characteristics. For example, the dynamic provider prioritizing system can determine dynamic provider network status characteristics of a provider device associated with a transportation matching system and provide, to the requester via a requester client device, a selectable option to prioritize transportation matches with providers having the dynamic provider network status characteristics.

As mentioned above, in some implementations, the dynamic provider prioritizing system selects between multiple provider prioritization models for different geographic locations. For example, the dynamic provider prioritizing system can select between a self-executing provider prioritization model, a requester selected network characteristics prioritization model, and one or more other transportation matching models. In some implementations, the dynamic provider prioritizing system intelligently selects and implements these various models based on geographic location or other factors (e.g., detecting utilization of other third party transportation matching applications or prioritization frameworks within a geographic area).

As just mentioned, in some implementations, the dynamic provider prioritizing system utilizes a self-executing provider prioritization model that automatically prioritizes provider devices that exhibit certain dynamic provider network status characteristics. For example, the dynamic provider prioritizing system can monitor dynamic provider network status characteristics and compare the dynamic provider network status characteristics to certain thresholds. If a provider device satisfies these thresholds (e.g., preferred/prioritized provider thresholds), the dynamic provider prioritizing system can prioritize these provider devices in applying a transportation matching algorithm. For example, the dynamic provider prioritizing system can apply a transportation value modifier to these preferred/prioritized provider devices and/or generate prioritized transportation matches (e.g., such that the preferred provider devices receive an additional number or percentage of transportation matches relative to other provider devices).

In addition, in some implementations, the dynamic provider prioritizing system selects and utilizes a requester selected network characteristics prioritization model that applies different prioritization approaches in response to requester client device interaction/selection. For example, the dynamic provider prioritizing system can provide a user interface to a requester client device that includes a prioritizing provider matching opt-in element (that corresponds to dynamic provider network status characteristics). Thus, requester client devices can decide to opt-in to prioritized matching with provider devices that align with particular dynamic provider network status characteristics. The dynamic provider prioritizing system can monitor dynamic provider network status characteristics of provider devices and compare the dynamic provider network status characteristics to corresponding thresholds. If a provider device satisfies these thresholds, the dynamic provider prioritizing system can prioritize these provider devices in applying a transportation matching algorithm. In some implementations, the dynamic provider prioritizing system applies different prioritization approaches when utilizing requester selected network characteristics prioritization model (e.g., generates prioritized transportation matches without applying a transportation value modifier).

As mentioned previously, conventional systems suffer from a number of technical problems, particularly in flexibility, efficiency, and precision of implementing computer devices. For example, conventional systems generally utilize rigid transportation matching algorithms to generate transportation matches between requester and provider devices. Indeed, conventional systems utilize a rigid approach that fails to adjust or vary based on different contextual features. Furthermore, conventional systems impose these rigid features on provider devices or requester client devices in generating transportation matches.

Similarly, as a result of this inflexibility, conventional systems are often inaccurate and inefficient in generating transportation matches. For example, conventional systems align provider devices and requester client devices without regard to individual requester client device or provider device contextual interactions or preferences. Thus, conventional systems will often generate transportation matches between requester client devices and provider devices that fail to match requester client device or provider device contextual preferences, resulting in devices navigating to different applications or imposing additional bandwidth resources associated with duplicative queries (e.g., cancelling matches, opening and closing the application, etc.).

For example, requester client devices faced with a rigid assignment to a particular transportation match will often review details of the transportation match, cancel the corresponding transportation request, and restart a mobile application to submit an additional transportation request in hopes of receiving a more desirable transportation match. Similarly, provider devices faced with a rigid assignment to a particular transportation request will often review details regarding the transportation match, change a mobile application to an offline status (or otherwise submit a cancellation notice for the transportation request), switch the mobile application back to online status (or otherwise restart the mobile application), wait for the system to identify an additional transportation match, and re-evaluate the additional transportation match for compatibility.

Indeed, conventional systems can iteratively repeat these respective processes before a requester client device or provider device accepts a transportation match. This not only wastes computer resources of the respective requester or provider device, but backend servers utilize significant computer resources in iteratively managing transportation matches, processing cancellation requests, and reassigning requests across multiple requester and provider devices. Accordingly, conventional systems suffer from inefficient utilization of computing resources (e.g., memory and processing power), excessive bandwidth utilization, and increased latency.

As suggested above, the disclosed dynamic provider prioritizing system provides several technical improvements or advantages over conventional systems. For instance, the dynamic provider prioritizing system can improve flexibility and computer functionality relative to conventional systems. Indeed, unlike conventional systems the dynamic provider prioritizing system can intelligently select between, and implement, different provider prioritization models. For example, in different geographic regions the dynamic provider prioritizing system can select and implement a self-executing provider prioritization model, a requester selected network characteristics prioritization model, and other prioritization models. Moreover, as mentioned above, the dynamic provider prioritizing system can implement a requester selected network characteristics prioritization model that flexibly allows requester client devices to opt-in to particular dynamic provider network status characteristics to emphasize in generating transportation matches (such as risk signals or provider network interactions). This approach provides improved flexibility across a transportation matching system in selecting between appropriate models and/or allowing requester client devices to opt-in to certain prioritized matching processes based on network status characteristics that providers can dynamically modify to satisfy certain thresholds associated with the requester selected network characteristics prioritization model.

The dynamic provider prioritizing system can also improve accuracy and efficiency. Indeed, the dynamic provider prioritizing system can consider requester contextual selections (or provider contextual selections) of a prioritized model in generating transportation matches to improve matches between requester client devices and provider devices. This approach provides more accurate matches and a reduction in load/bandwidth of implementing devices. For example, improved transportation matches can result in reduced interactions that often degrade network efficiency and overall performance.

As indicated by the foregoing discussion, the present disclosure utilizes a variety of terms to describe features and advantages of the dynamic provider prioritizing system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider- or a device associated with an autonomous vehicle that drives along transportation routes.

As suggested above, the term “requester client device” refers to a computing device associated with a requester that submits a transportation request to a transportation matching system. For instance, a requester client device receives interaction from a requester in the form of user interaction to submit a transportation request. After the transportation matching system matches a requester (or a requester client device) with a provider (or a provider device), the requester can await pickup by the provider at a predetermined pick-up location. Upon pick-up, the provider transports the requester to a drop-off location specified in the requester's transportation request. Accordingly, a requester may refer to (i) a person who requests a request or other form of transportation but who is still waiting for pickup, (ii) a person who requests a request or other form of transportation for another person, or (iii) a person whom a transportation vehicle has picked up and who is currently riding within the transportation vehicle to a drop-off location.

As used herein, the term “transportation request” refers to a request from a requesting device (i.e., a requester client device) for transport by a transportation vehicle. In particular, a transportation request includes a request for a transportation vehicle to transport a requester or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester client device initiating a session via a transportation matching application and transmitting a current location (thus, indicating a desire to receive transportation services from the current location).

Relatedly, as used herein, the term “dynamic provider network status characteristics” refers to transportation characteristics associated with a provider device. In particular, dynamic provider network status characteristics include characteristics related to performance or interactions of the provider device with a transportation matching system/server. For example, the dynamic provider network status characteristics can include risk signals from telematics data monitored while a provider device is transporting a requester client device. Dynamic provider network status characteristics can also include provider network interactions, such as interactions indicating acceptance/rejection of transportation requests. Thus, as used herein, the term “risk signals” refers to indicators, metrics, or features indicating risk associated with a provider device. For example, risk signals can include telematics data or requester client device transmissions indicating harsh acceleration, harsh corners, or distracted utilizing of a provider device during operation of a vehicle. Moreover, as used herein, the term “provider network interactions” refers to interactions with a transportation application of a provider device transmitted across computer networks (e.g., to a server of a transportation matching system). For example, provider network interactions can include a user interaction with a user interface accepting a transportation request/match transmitted by a server to the provider device. Similarly, provider network interactions can include a user interaction with a user interface cancelling or rejecting a transportation request/match transmitted by a server to the provider device.

Relatedly, as used herein, the term “set of prioritized provider devices” refers to a group of provider devices that meet one or more dynamic provider network status characteristics. In particular, the set of prioritized provider devices meet or exceed thresholds for risk signals and/or provider network interactions and, as a result, receive transportation value modifiers and/or prioritized transportation matches.

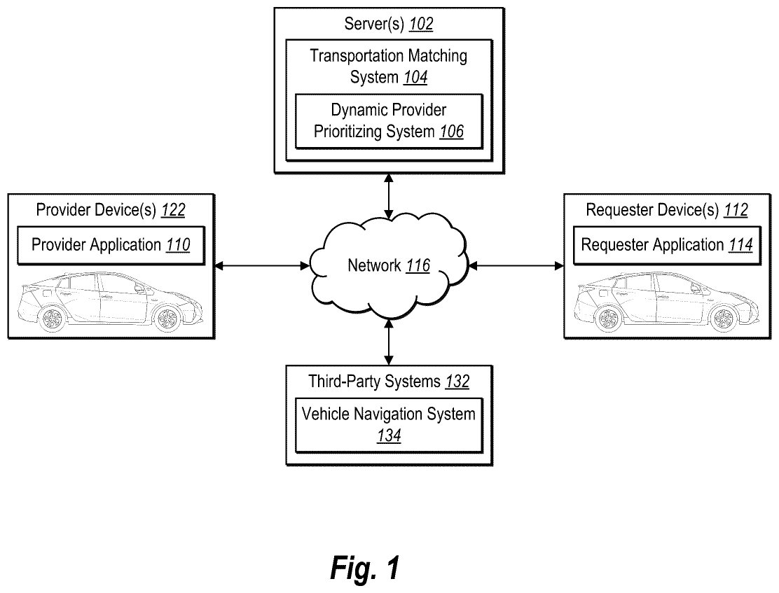

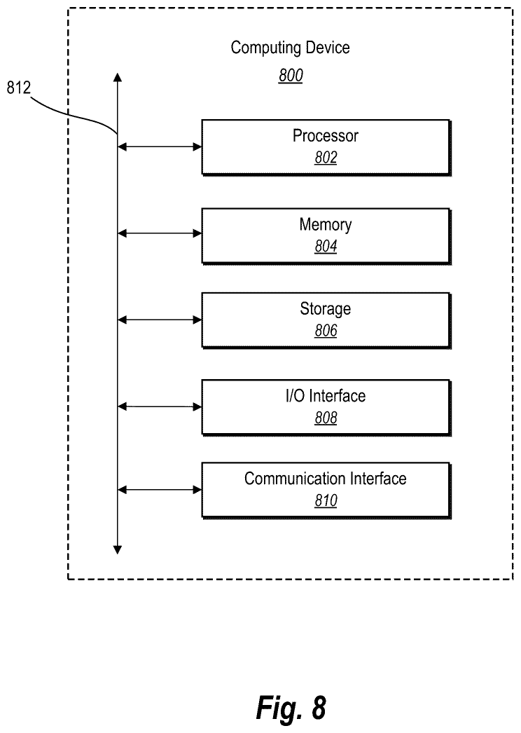

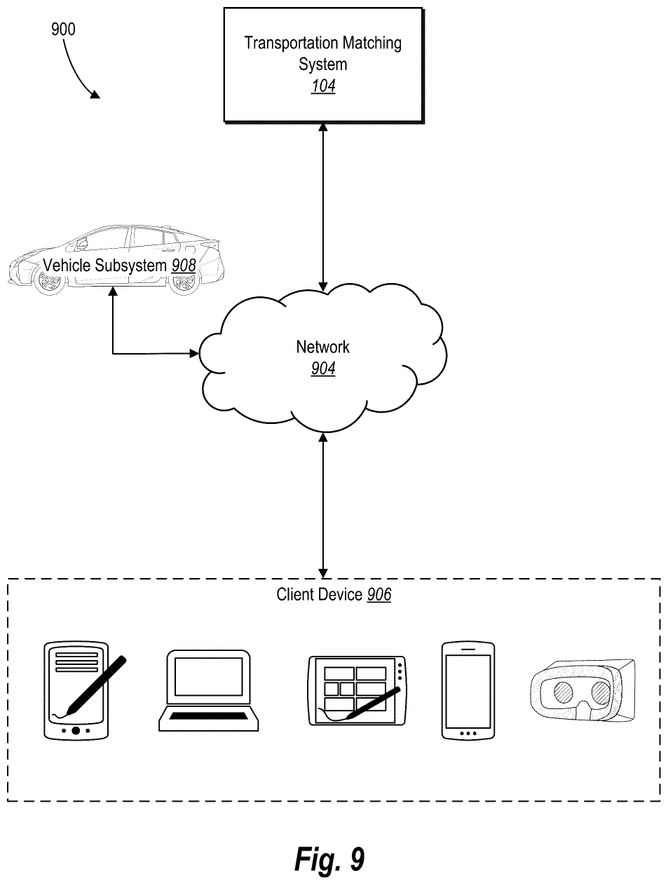

Additional detail regarding the dynamic provider prioritizing system will now be provided with reference to the figures. In particular, FIG. 1 illustrates a block diagram of a system environment for implementing a dynamic provider prioritizing system 106 in accordance with one or more embodiments. As shown in FIG. 1, the environment includes server(s) 102 housing the dynamic provider prioritizing system 106 as part of a transportation matching system 104. The environment of FIG. 1 further includes a provider device(s) 122 (including a provider application 110) and a requester client device(s) 112 (including a requester application 114), as well as a network 116. The server(s) 102 can include one or more computing devices to implement the dynamic provider prioritizing system 106. The environment of FIG. 1 further includes a third-party system(s) 132 (including a vehicle navigation system 134). Additional detail regarding the illustrated computing devices (e.g., the server(s) 102, the provider device(s) 122, the requester client device(s) 112, and/or the third-party system(s) 132) is provided with respect to FIGS. 8-9 below.

As shown, the dynamic provider prioritizing system 106 utilizes the network 116 to communicate with the provider device(s) 122 and the requester client device(s) 112. The network 116 may comprise any network described in relation to FIGS. 8-9. For example, the dynamic provider prioritizing system 106 communicates with the provider device(s) and the requester client device(s) 112 to match transportation requests received from the requester client device(s) 112 with the provider device(s) 122. Indeed, the transportation matching system 104 or the dynamic provider prioritizing system 106 can receive a transportation request from the requester client device(s) 112 and can provide request information to various provider devices, such as a requested location (e.g., a requested pickup location and/or a requested drop-off location), a requester identification (e.g., for a requester corresponding to the requester client device(s) 112), and an indication of whether a requester has elected to participate in prioritized provider matches. In some embodiments, per device settings, the transportation matching system 104 or the dynamic provider prioritizing system 106 receives device information from various provider devices and the requester client device(s) 112, such as location coordinates (e.g., latitude, longitude, and/or elevation), orientations or directions, motion information, and indications of user interactions with various interface elements.

To facilitate connecting transportation requests with transportation vehicles, in some embodiments, the transportation matching system 104 or the dynamic provider prioritizing system 106 communicates with the provider device(s) 122 and other provider devices (e.g., through a provider application 110). As indicated by FIG. 1, the provider device(s) 122 includes the provider application 110. In many embodiments, the transportation matching system 104 or the dynamic provider prioritizing system 106 communicates with the provider device(s) 122 through the provider application 110 to, for example, receive and provide information including location data, motion data, transportation request information (e.g., pickup locations and/or drop-off locations), and transportation route information for navigating to one or more designated locations. Further, in some embodiments, the dynamic provider prioritizing system 106 communicates with the provider device(s) 122 through the provider application 110 to determine one or more contextual characteristics of the provider(s) associated with the provider device(s) 122 and, in response, provide a selectable option to prioritize contextual transportation matches with the provider device(s) 122.

Similarly, the transportation matching system 104 or the dynamic provider prioritizing system 106 communicates with the requester client device(s) 112 (e.g., through the requester application 114) to facilitate connecting requests with transportation vehicles. In many embodiments, the dynamic provider prioritizing system 106 communicates with the requester client device(s) 112 through the requester application 114 to, for example, receive and provide information including location data, motion data, transportation request information (e.g., requested locations), and navigation information to guide a requester to a designated location. Further, in some embodiments, the dynamic provider prioritizing system 106 communicates with the provider device(s) 122 through the provider application 110 to determine one or more dynamic provider network status characteristics associated with the provider device(s) 122. Moreover, in some embodiments, the dynamic provider prioritizing system 106 communicates with the requester client device(s) 122 through the requester application 114 to determine an interaction with a prioritizing provider matching opt-in element, and, in response generate a prioritized transportation match according to one or more dynamic provider network status characteristics.

As indicated above, the transportation matching system 104 or the dynamic provider prioritizing system 106 can provide (and/or cause the provider device(s) 122 to display or render) visual elements within a graphical user interface associated with the provider application 110 and the requester application 114. For example, the transportation matching system 104 or the dynamic provider prioritizing system 106 can provide a digital map for display on the provider device(s) 122 that illustrates a transportation route to navigate to a designated location. The dynamic provider prioritizing system 106 can also provide a transportation request notification for display on the provider device(s) 122 indicating a transportation request.

Moreover, as illustrated the dynamic provider prioritizing system 106 provides a user interface via the requester client device(s) 112 that includes selectable options for various types of transportation requests. To illustrate, a selectable option for a prioritized transportation matches (e.g., a prioritizing provider matching opt-in element) can include additional detail about prioritized transportation matching, such as the dynamic provider network status characteristics upon which the prioritized transportation is based, and a notification that prioritized transportation matches will be implemented when available.

Although FIG. 1 illustrates the environment having a particular number and arrangement of components associated with the dynamic provider prioritizing system 106, in some embodiments, the environment may include more or fewer components with varying configurations. For example, in some embodiments, the transportation matching system 104 or the dynamic provider prioritizing system 106 can communicate directly with the provider device(s) 122 and/or the requester client device(s) 112, bypassing the network 116. In these or other embodiments, the transportation matching system 104 or the dynamic provider prioritizing system 106 can be housed (entirely on in part) on the provider device(s) 122 and/or the requester client device(s) 112. Additionally, the transportation matching system 104 or the dynamic provider prioritizing system 106 can include or communicate with a database for storing information, such as various machine learning models, historical data (e.g., historical provider device and/or requester client device patterns), transportation requests, and/or other information described herein.

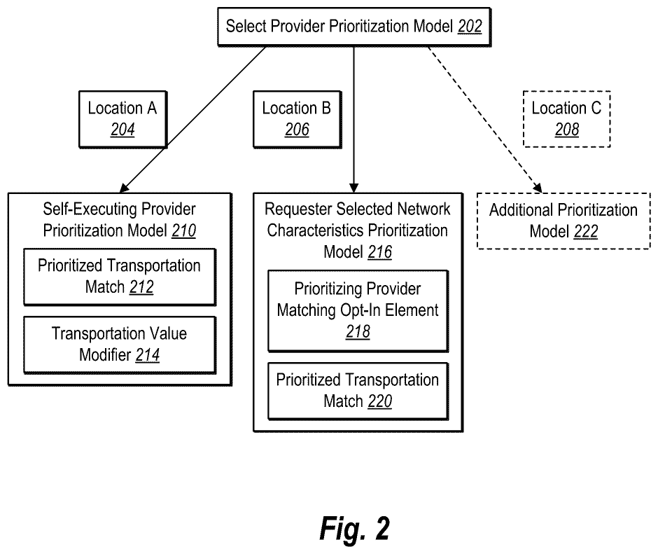

As mentioned previously, in one or more embodiments, the dynamic provider prioritizing system 106 generates prioritized transportation matches between requester client devices and provider devices according to one or more provider prioritization models. For example, FIG. 2 illustrates an example diagram of determining a provider prioritization model for requester and provider devices.

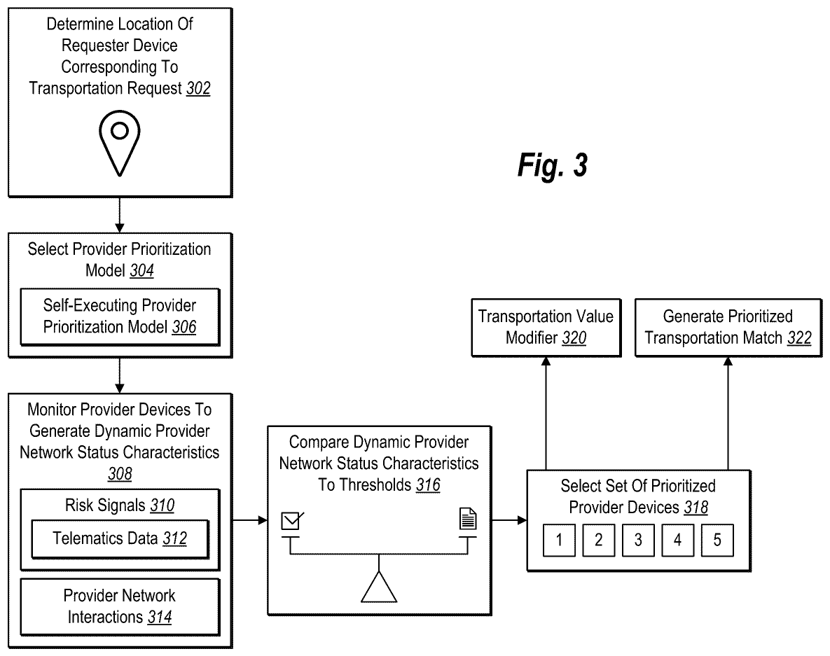

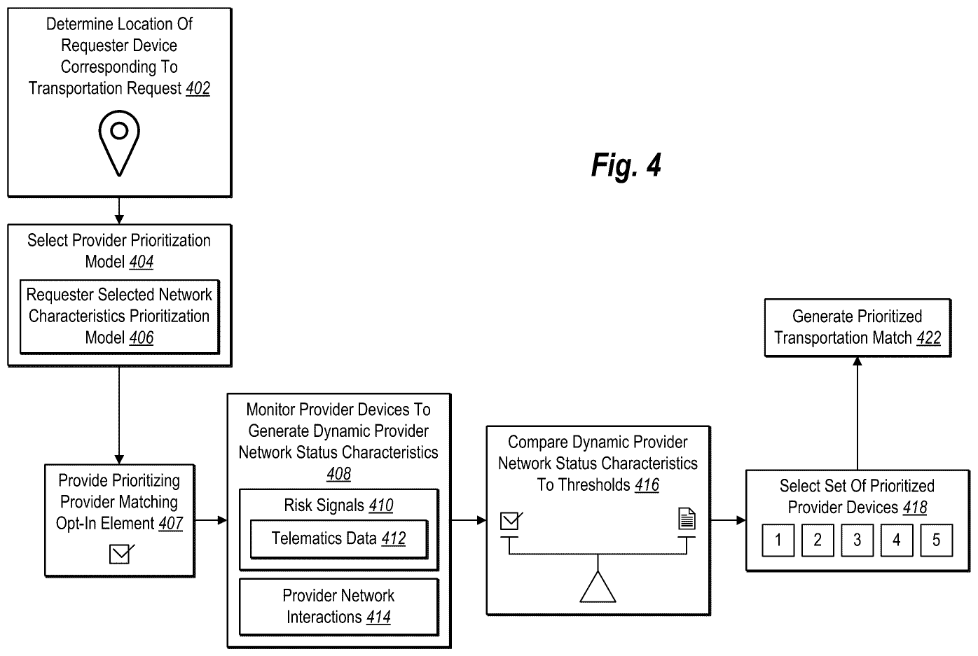

Specifically, FIG. 2 illustrates the dynamic provider prioritizing system 106 performing an act 202 to select a provider prioritization model. The dynamic provider prioritizing system 106 can select the provider prioritization model according to a geographic location of a provider device and/or a requester client device. In addition to determining the provider prioritization model according to the geographic location of the provider device and/or the requester client device, the dynamic provider prioritizing system 106 can determine an eligibility of the provider device to utilize the determined provider prioritization model according to risk signals and provider network interactions. More information regarding provider device eligibility to utilize provider prioritization models can be found below with regard to FIGS. 3 and 4.

As illustrated, the dynamic provider prioritizing system 106 can determine that a first requester client device and/or a first provider device is in location A 204. Location A 204 can be one or more cities, one or more counties, one or more states, or any combination thereof (e.g., location A 204 can be a first set of locations). Responsive to determining that the first requester client device and/or the first provider device is in location A 204, the dynamic provider prioritizing system 106 can automatically select a self-executing provider prioritization model 210 and implement the self-executing provider prioritization model 210 with regard to the first requester client device and/or the first provider device. More information regarding the self-executing provider prioritization model 210 can be found below with regard to FIG. 3.

Indeed, the dynamic provider prioritizing system 106 can utilize the self-executing provider prioritization model 210 to implement a transportation value modifier 214 for the first provider device. For example, the dynamic provider prioritizing system 106 can include a transportation value modifier that increases the value of a transportation service by a certain amount or percentage (e.g., 5% or 10% increase over non-preferred/non-prioritized driver devices). Additionally, the dynamic provider prioritizing system 106 can cause the self-executing provider prioritization model 210 to generate a prioritized transportation match 212 for the first provider device and/or the first requester client device. For example, the prioritized transportation match can include an increased weight or rate of matches for a preferred (e.g., prioritized) provider device (e.g., increased weight so that preferred provider devices receive 5% or 10% more transportation matches relative to non-preferred provider devices).

Moreover, as a result of performing the act 202 to select a provider prioritization model, the dynamic provider prioritizing system 106 can determine that a second requester client device and/or a second provider device is in location B 206. Location B 206 can be one or more cities, one or more counties, one or more states, or any combination thereof (e.g., location B 206 can be a second set of locations). Responsive to determining that the second requester client device and/or the second provider device is in location B 206, the dynamic provider prioritizing system 106 can select and implement a requester selected network characteristics prioritization model 216. More information regarding the requester selected network characteristics prioritization model 216 can be found below with regard to FIG. 4.

As shown, the dynamic provider prioritizing system 106 can utilize the requester selected network characteristics prioritization model 216 to provide a prioritizing provider matching opt-in element 218 and to generate a prioritized transportation match 220. Specifically, the dynamic provider prioritizing system 106 can generate the prioritizing provider matching opt-in element in a user interface of the second provider device to enable the second provider device to opt in to the requester selected network characteristics prioritization model 216. Responsive to detecting an interaction with the prioritizing provider matching opt-in element 218, the dynamic provider prioritizing system 106 can utilize the second provider device to generate a prioritized transportation match 220 with a requester client device, such as, for example, the second requester client device.

Indeed, as shown, in some embodiments, the dynamic provider prioritizing system 106 can perform the act 202 to select the provider prioritization model, the dynamic provider prioritizing system 106 can determine that a third provider device and/or a third requester client device is in location C 208. Location C 208 can be one or more cities, one or more counties, one or more states, or any combination thereof (e.g., location C 208 can be a third set of locations). Based on determining that the third provider device and/or third requester client device is located in location C 208, the dynamic provider prioritizing system 106 can determine to utilize an additional prioritization model 222 to generate transportation matches for the third provider device and/or the third requester client device. For example, the dynamic provider prioritizing system 106 can utilize an additional requester selected network characteristics prioritization model with different characteristics or thresholds (e.g., without applying a transportation match acceptance threshold or some other threshold/characteristic).

As mentioned previously, in one or more embodiments, the dynamic provider prioritizing system 106 utilizes a self-executing prioritization model to generate transportation matches for provider devices and requester client devices. To further illustrate. FIG. 3 depicts the dynamic provider prioritizing system 106 utilizing the self-executing provider prioritization model to generate prioritized transportation matches.

As shown in FIG. 3, the dynamic provider prioritizing system 106 can perform an act 302 to determine the location of a requester client device corresponding to a transportation request. The dynamic provider prioritizing system 106 can determine the location of the requester client device utilizing GPS data associated with the requester client device and/or the transportation request.

As illustrated, responsive to determining the location of the requester client device, the dynamic provider prioritizing system 106 can perform an act 304 to select a provider prioritization model. Specifically, the dynamic provider prioritizing system 106 can determine, based on the location of the requester client device and/or the transportation request, to automatically implement a self-executing provider prioritization model 306 for the requester client device. For instance, the self-executing provider prioritization model 306 can automatically prioritize certain provider devices in generating transportation matches (e.g., identify preferred or prioritized provider devices based on determining that dynamic provider network status characteristics satisfy certain thresholds).

Responsive to determining the self-executing provider prioritization model 306, the dynamic provider prioritizing system 106 can perform an act 308 to monitor provider devices to generate dynamic provider network status characteristics. Specifically, the dynamic provider prioritizing system 106 can monitor risk signals 310 of provider devices. For example, the dynamic provider prioritizing system 106 can utilize telematics data 312 to determine risk patterns for provider devices, such as sudden/aggressive acceleration or deceleration, prolonged time periods driving at high velocity, incomplete stops at stop signs, not stopping at traffic lights sudden lane changes, among others. Similarly, the dynamic provider prioritizing system 106 can monitor risk signals from requester client devices. For example, the dynamic provider prioritizing system 106 can monitor telematics data from requester client devices. The dynamic provider prioritizing system 106 can also receive user interactions from requester client devices indicating interactions with risk elements via a user interface of the requester client device. To illustrate, the dynamic provider prioritizing system 106 can receive an indication from requester client devices of a selection of a risk element (e.g., a risk rating button or risk flag button) during transportation services from a provider device. The dynamic provider prioritizing system 106 can utilize such an indication as a risk signal for the provider device. In one or more implementations, the dynamic provider prioritizing system 106 can generate combined/weighted risk score from various risk signals (e.g., combine sharp acceleration events, risk reports from requester client devices, etc. utilizing different weights to generate an overall risk score).

Additionally, as shown, the dynamic provider prioritizing system 106 can perform the act 308 to monitor provider devices to generate dynamic provider network status characteristics by monitoring provider network interactions 314. For example, the dynamic provider prioritizing system 106 can monitor provider network interactions 314 by monitoring acceptance rates of provider vehicles (e.g., the dynamic provider prioritizing system 106 can determine, for each provider device qualified to utilize the self-executing provider prioritization model 306, what percentage of transportation requests each provider device accepts). In addition to monitoring acceptance rates, the dynamic provider prioritizing system 106 can monitor provider network interactions 314 by monitoring cancellation rates associated with provider devices (e.g., the dynamic provider prioritizing system 106 can monitor how many transportation requests each provider device cancels after initially accepting the transportation request).

As illustrated, based on the dynamic provider network status characteristics, the dynamic provider prioritizing system 106 can perform an act 316 to compare the dynamic provider network status characteristics to dynamic provider network status characteristics thresholds. For example, the dynamic provider prioritizing system 106 can determine the dynamic provider network status characteristics thresholds according to the location of the requester client device and/or the provider prioritization model the dynamic provider prioritizing system 106 determines for the requester client device.

Based on comparing the dynamic provider network status characteristics to the dynamic provider network status characteristics thresholds, the dynamic provider prioritizing system 106 can perform an act 318 to select a set of prioritized provider devices that are eligible to utilize the self-executing provider prioritization model 306. As part of the self-executing provider prioritization model, the dynamic provider prioritizing system 106 can provide a transportation value modifier 320 to each prioritized provider device of the set of prioritized provider devices to increase a value of a transportation request for each prioritized provider device. Moreover, the dynamic provider prioritizing system 106 can perform an act 322 to generate a prioritized transportation match by determining a prioritized provider device of the set of prioritized provider devices to match to the requester client device.

Additionally, in some embodiments, the dynamic provider prioritizing system 106 can provide a prioritized transportation matches to preferred/prioritized provider devices. As an example, the dynamic provider prioritizing system 106 can apply a transportation rate modifier or transportation match weight modifier to each prioritized provider device of the set of prioritized provider devices to increase the rate at which the dynamic provider prioritizing system 106 matches each prioritized provider device of the set of prioritized provider devices to transportation requests. By providing both a transportation value modifier and a transportation rate modifier, the dynamic provider prioritizing system 106 can utilize the self-executing provider prioritization model 306 to incentivize provider devices to satisfy criteria/thresholds to become prioritized provider devices.

Moreover, in some embodiments, the dynamic provider prioritizing system 106 can provide an option for prioritized provider devices to opt-out of self-executing provider prioritization model 306. For example, based on user interaction with an opt-out element of a user interface, provider devices can opt-out of prioritized transportation matches and/or transportation value modifiers associated with the self-executing provider prioritization model 306. In response, the dynamic provider prioritizing system 106 can withhold transportation rate modifiers and/or transportation value modifiers to such provider devices in generating transportation matches.

As previously mentioned, in some embodiments, the dynamic provider prioritizing system 106 can utilize a requester selected network characteristics prioritization model. FIG. 4 illustrates the dynamic provider prioritizing system 106 utilizing a requester selected network characteristics prioritization model to generate prioritized transportation matches.

As illustrated in FIG. 4, the dynamic provider prioritizing system 106 can perform an act 402 to determine the location of a requester client device corresponding to a transportation request. The dynamic provider prioritizing system 106 can utilize GPS data associated with the requester client device and/or the transportation request to determine the location.

As shown, the dynamic provider prioritizing system 106 can perform an act 404 to select a provider prioritization model for the requester client device. For example, the dynamic provider prioritizing system 106 can utilize the location of the requester client device to select the provider prioritization model. Specifically, the dynamic provider prioritizing system 106 can determine, based on the location of the requester client device to provide the requester client device an opportunity to join a requester selected network characteristics prioritization model 406.

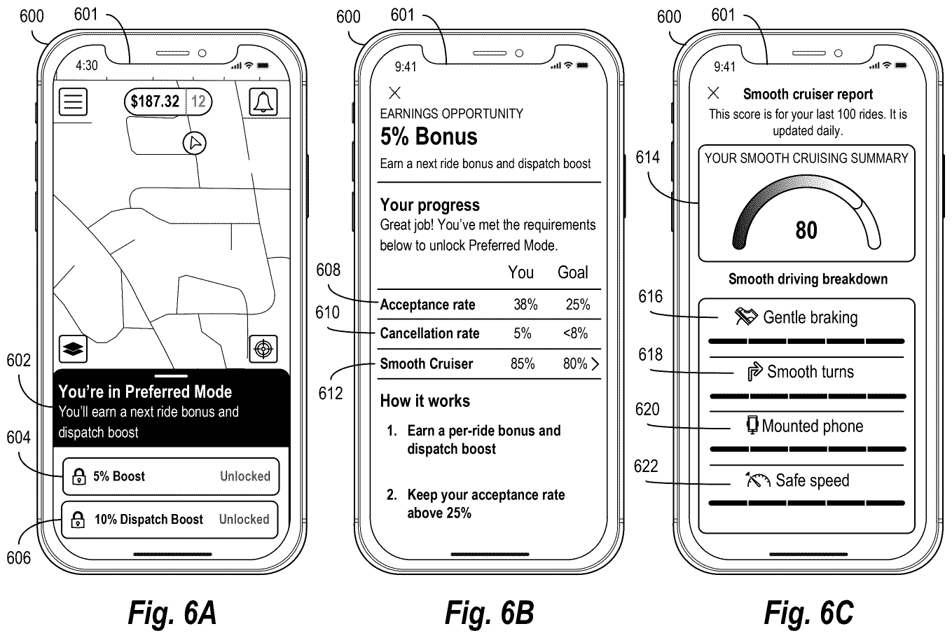

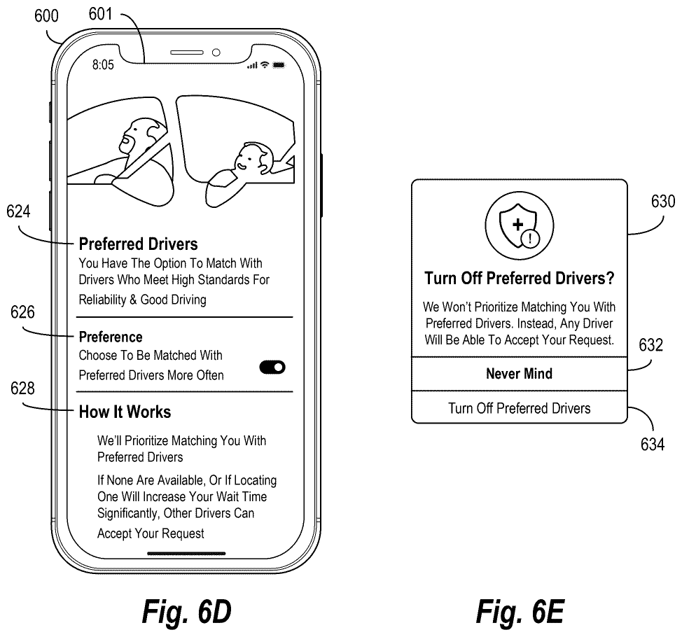

As illustrated, responsive to determining to provide the requester client device an opportunity to join the requester selected network characteristics prioritization model 406, the dynamic provider prioritizing system 106 can generate a prioritizing provider matching opt-in element and perform an act 407 to provide the prioritizing provider matching opt-in element in a user interface of the requester client device. Indeed, in some embodiments the dynamic provider prioritizing system 106 can provide the prioritizing provider matching opt-in element to provider devices as well as to requester client devices. In this manner, the dynamic provider prioritizing system 106 can utilize the prioritizing provider matching opt-in element to receive indications of consent (e.g., such as a tap, a click, or a swipe) from provider devices and requester client devices to enable the dynamic provider prioritizing system 106 to generate prioritized provider matches. More information regarding the prioritizing provider opt-in element can be found below with regard to FIGS. 6A-6E.

As shown, the dynamic provider prioritizing system 106 can perform an act 408 to monitor provider devices to determine dynamic provider network status characteristics. For example, the dynamic provider prioritizing system 106 can determine the dynamic provider network status characteristics by determining risk signals 410 for the provider devices. Indeed, the dynamic provider prioritizing system 106 can utilize telematics data 412 to determine transportation and/or driving patterns for the provider devices and determine risk signals from the transportation and/or driving patterns. Similarly, the dynamic provider prioritizing system 106 can monitor requester client devices for risk flags (selection of a risky driving element via a user interface) for a provider device. Moreover, the dynamic provider prioritizing system 106 can monitor provider network interactions 414 for the provider devices to determine negative network interactions such low acceptance rates of transportation requests by provider devices or high cancellation rates of transportation requests by provider devices.

As illustrated, responsive to performing act 408 to monitor provider devices to generate dynamic provider network status characteristics, the dynamic provider prioritizing system 106 can perform an act 416 to compare the dynamic provider network status characteristics with threshold dynamic provider network status characteristics (or network status thresholds for short). The dynamic provider prioritizing system 106 can determine the network status thresholds according to the provider prioritization model (e.g., the dynamic provider prioritizing system 106 can set different threshold dynamic provider network status characteristics for different provider prioritization models), or according to other factors.

As shown, based on performing the act 416 to compare the dynamic provider network status characteristics to threshold dynamic provider network status characteristics, the dynamic provider prioritizing system 106 can perform an act 418 to select a set of prioritized provider devices from the provider devices. Specifically, the dynamic provider prioritizing system 106 can select the set of prioritized provider devices from the provider devices by determining one or more provider devices that meet the threshold dynamic provider network status characteristics (e.g., by determining one or more provider devices that meet requirements for risk signals and provider network interactions).

Based on selecting the set of prioritized provider devices, the dynamic provider prioritizing system 106 can perform an act 422 to generate a prioritized transportation match for the requester client device. Specifically, the dynamic provider prioritizing system 106 can select a prioritized provider device from the set of prioritized provider devices to fulfil the transportation request of the requester client device. For example, in applying a transportation matching model, the dynamic provider prioritizing system 106 can apply added weight to preferred/prioritized provider devices in generating transportation matches (for requester client devices that have opted in to the requester selected network characteristics prioritization model and for provider devices that satisfy the associated characteristics associated with the requester client device selection).

In some embodiments, the dynamic provider prioritizing system 106 can implement a location-specific rider prioritization framework that includes multiple rider prioritization transportation models. Specifically, the dynamic provider prioritizing system 106 can generate each rider prioritization transportation model of the location-specific rider prioritization framework to correspond to a specific geographic location. Additionally, in some embodiments the dynamic provider prioritizing system 106 can generate or otherwise train each rider prioritization transportation model to include a prioritizing provider matching opt-in element. Further, the dynamic provider prioritizing system 106 can generate each rider prioritization transportation model to provide different types of transportation value modifiers and/or to generate prioritized transportation matches according to different criteria (e.g., different dynamic provider network status characteristics).

As mentioned above, the dynamic provider prioritizing system 106 can provide different prioritization frameworks for the requester selected network characteristics prioritization model. For example, in some implementations, in applying the requester selected network characteristics prioritization model, the dynamic provider prioritizing system 106 applies prioritized transportation matches (e.g., utilizing a transportation rate modifier) without a corresponding transportation value modifier. In some implementations, the dynamic provider prioritizing system 106 applies a different transportation rate modifier (e.g., between 10%-15% instead of 10%) for the requester selected network characteristics prioritization model. Moreover, the requester selected network characteristics prioritization model can also utilize different thresholds.

Moreover, in some embodiments, the dynamic provider prioritizing system 106 can provide an option for prioritized provider devices to opt-out of the requester selected network characteristics prioritization model 406. For example, based on user interaction with an opt-out element of a user interface, provider devices can opt-out of prioritized transportation matches associated with the requester selected network characteristics prioritization model 406.

Additionally, in some embodiments, the dynamic provider prioritizing system 106 can generate and/or select an additional prioritization model for a provider device and/or a requester client device according to geographic location, based on changing the requirements for a provider device to qualify for the additional prioritization model (e.g., the quantity of dynamic provider network status characteristics and/or the threshold dynamic provider network status characteristics), or based on changing the benefits the dynamic provider prioritizing system 106 provides to the set of prioritized provider devices (e.g., the transportation value modifier and/or the transportation rate modifier).

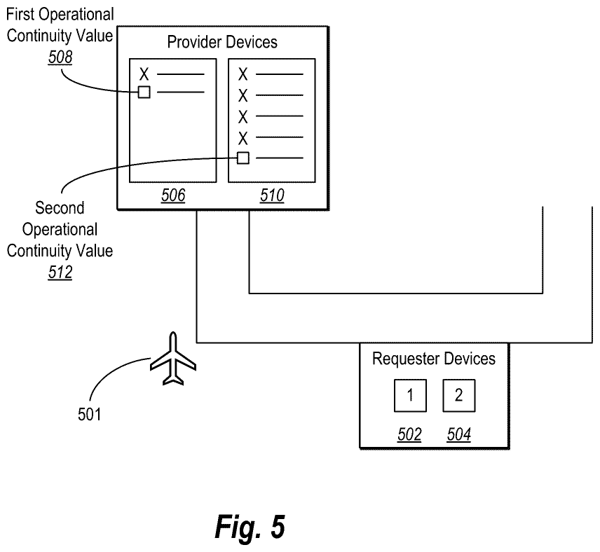

In one or more embodiments, the dynamic provider prioritizing system 106 implements different operational continuity thresholds for preferred (e.g., prioritized) provider devices to generate transportation matches at certain specialized locations (e.g., airports or high-volume events). For example, FIG. 5 illustrates the dynamic provider prioritizing system 106 determining to implement different operational continuity thresholds for preferred provider devices relative to non-preferred provider devices according to a location of the transportation requests.

As shown in FIG. 5, the dynamic provider prioritizing system 106 can perform an act 501 to determine a location of a transportation request associated with a requester client device. Based on determining the location of the transportation request, the dynamic provider prioritizing system 106 can determine to implement one or more operational continuity policies to improve the efficiency and accuracy of the transportation matching system. For example, in FIG. 5, the dynamic provider prioritizing system 106 can determine that the location associated with the one or more transportation requests is an airport. Based on determining the location is an airport, the dynamic provider prioritizing system 106 can implement different operational continuity thresholds for preferred provider devices (relative to non-preferred provider devices).

As used herein, an “operational continuity” refers to a measure of continued provider device availability to accept transportation requests. Thus, for example, an operational continuity threshold includes a limit on unavailability of a provider device to accept transportation requests. For example, if a provider device is unavailable (e.g., for a threshold number of lapses), the dynamic provider prioritizing system 106 can apply a cool down period (e.g., a period where the provider device will no longer receive transportation matches). The dynamic provider prioritizing system 106 can apply a different operational continuity threshold (e.g., a different number of threshold lapses) for preferred provider devices compared to non-preferred provider devices in some implementations.

As shown in FIG. 5, the dynamic provider prioritizing system 106 can receive a first transportation request from a first requester client device 502, and a second transportation request from a second requester client device 504. Responsive to receiving the transportation requests, the dynamic provider prioritizing system 106 can determine a set of provider devices (e.g., a non-prioritized provider device 506 and a prioritized provider device 510). The dynamic provider prioritizing system 106 can determine a first operational continuity value 508 for the non-prioritized provider device 506. For example, the dynamic provider prioritizing system 106 can determine that the non-prioritized provider device 506 rejected a first transportation request. Additionally, the dynamic provider prioritizing system 106 can determine a second operational continuity value 512 for the prioritized provider device 510. For example, the dynamic provider prioritizing system 106 can determine that the prioritized provider device 510 rejected four consecutive transportation requests.

Responsive to determining the operational continuity values (e.g., the first operational continuity value 508 and the second operational continuity value 512), the dynamic provider prioritizing system 106 can compare the operational continuity values to different operational continuity thresholds (e.g., a threshold of 1 for the non-prioritized provider device 506 and a threshold of 5 for the prioritized provider device 510). Responsive to determining that an operational continuity value exceeds the corresponding operational continuity threshold, the dynamic provider prioritizing system 106 can assign a corrective action to the prioritized provider device associated with the operational continuity value above the operational continuity threshold. For example, responsive to determining that the first operational continuity value 508 (e.g., the operational continuity value associated with the prioritized provider device 510) satisfies the first operational continuity threshold (e.g., 1), the dynamic provider prioritizing system 106 can require the non-prioritized provider device 506 to wait a buffer period before providing the non-prioritized provider device 506 with a transportation match. Additionally or alternatively, the dynamic provider prioritizing system 106 can decrease a transportation value modifier and/or a transportation rate modifier associated with the prioritized provider device 510 as a corrective action.

Similarly, responsive to determining that the second operational continuity value 512 (e.g., the operational continuity value associated with the prioritized provider device 510) does not satisfy the second operational continuity threshold (e.g., 5), the dynamic provider prioritizing system 106 can continue to provide transportation matches to the prioritized provider device 510 (e.g., until the second operational continuity threshold is satisfied). Although the foregoing example provided particular operational continuity thresholds, the dynamic provider prioritizing system 106 can utilize a variety of thresholds (e.g., 6 for non-prioritized drivers and 9 for prioritized drivers).

As mentioned previously, the dynamic provider prioritizing system 106 can generate one or more user interfaces associated with provider prioritization models for provider devices and/or requester client devices. FIGS. 6A-6E illustrate example user interfaces the dynamic provider prioritizing system 106 generates as a part of determining provider prioritization models for provider and requester client devices.

As illustrated in FIG. 6A, the dynamic provider prioritizing system 106 can provide a user interface 601 for display via a client device 600, such as a prioritized provider device. Indeed, the dynamic provider prioritizing system 106 can generate a first notification 602 to indicate that the client device is utilizing a self-executing provider prioritization model (e.g., “advantage mode”). Moreover, the dynamic provider prioritizing system 106 can generate a second notification 604 indicating that the dynamic provider prioritizing system 106 is providing the client device (e.g., a prioritized provider device) with a transportation value modifier (e.g., a “5% advantage boost”). In addition, the dynamic provider prioritizing system 106 can generate a third notification 606 indicating that the dynamic provider prioritizing system 106 is providing the client device (e.g., the prioritized provider device) with a transportation rate modifier (e.g., a “10% dispatch boost”).

Moreover, as shown in FIG. 6B, the dynamic provider prioritizing system 106 can provide information regarding risk signals and provider network interactions in the user interface 601 of the client device (e.g., the prioritized provider device). For example, the dynamic provider prioritizing system 106 can provide a first indication 608 of an acceptance rate (e.g., a first provider network interaction) of the prioritized provider device, as well as a threshold for the acceptance rate (e.g., a first network interaction threshold). Additionally, the dynamic provider prioritizing system 106 can provide a second indication 610 of a cancellation rate (e.g., a second network interaction) of the prioritized provider device, as well as a threshold for the cancellation rate (e.g., a second network interaction threshold). Moreover, the dynamic provider prioritizing system 106 can provide a third indication 612 of a driver rating (e.g., “smooth cruiser” or risk signal), as well as a threshold for the driver rating (e.g., a risk signal threshold). In addition, the dynamic provider prioritizing system 106 can generate each of the indications (e.g., the first indication 608, the second indication 610, and/or the third indication 612) to be selectable to provide more information.

For example, FIG. 6C shows the user interface 601 of the client device (e.g., the prioritized provider device) providing more information regarding the smooth cruiser summary (e.g., the risk signals). For example, the dynamic provider prioritizing system 106 can generate a first notification 614 indicating an overall driver rating. Additionally, the dynamic provider prioritizing system 106 can generate a first indication 616 (e.g., “gentle braking”) with a first rating in a first driving category (e.g., a first risk signal). Moreover, the dynamic provider prioritizing system 106 can generate a second indication 618 (e.g., “smooth turns”) with a second rating in a second driving category (e.g., a second risk signal). In addition, the dynamic provider prioritizing system 106 can generate a third indication 620 (e.g., “mounted phone”) with a third rating in a third driving category (e.g., a third risk signal). Indeed, the dynamic provider prioritizing system 106 can generate a fourth notification 622 (e.g., “safe speed”) with a fourth rating in a fourth driving category (e.g., a fourth risk signal).

Although FIGS. 6A-6C illustrate a user interface for a first prioritized provider model, the dynamic provider prioritizing system 106 can provide alternate user interfaces for a second prioritized provider model, such as a requester selected network characteristics prioritization model. For example, the dynamic provider prioritizing system 106 can modify the user interfaces of FIGS. 6A-6C to indicate a different model (e.g., “Preferred Mode” instead of “Advantage Mode”), different thresholds (e.g., omit acceptance rate or higher/lower thresholds), different prioritization indicators (e.g., only transportation rate modifier instead of a transportation value modifier), etc. In addition, the dynamic provider prioritizing system 106 can also provider user interfaces illustrating cumulative transportation value increases resulting from a prioritized mode and/or increased transportation matches resulting from a prioritized mode.

As shown in FIG. 6D, the dynamic provider prioritizing system 106 can generate notifications to provide in a user interface 601 of a client device 600 (e.g., a requester client device and/or a provider device). For example, the dynamic provider prioritizing system 106 can generate a first notification 624 to provide in the user interface 601 to provide an indication of the requester selected network characteristics prioritization model. Additionally, the dynamic provider prioritizing system 106 can provide a prioritizing provider matching opt-in element 626 corresponding to a plurality of dynamic provider network status characteristics (e.g., such as those discussed previously with respect to FIGS. 6B-6C). Indeed, the dynamic provider prioritizing system 106 can generate the prioritizing provider matching opt-in element 626 to be selectable to enable the client device (e.g., the requester client device and/or the provider device) to opt in to the requester selected network characteristics prioritization model. In addition, the dynamic provider prioritizing system 106 can generate an explanation notification 628 to explain, via the user interface 601 of the client device 600.

As shown in FIG. 6E, the dynamic provider prioritizing system 106 can generate an opt-out notification 630 (e.g., to provide in a user interface of a client device, such as a requester client device and/or a provider device) to allow the client device (e.g., the requester client device and/or the provider device) to opt out of the requester selected network characteristics prioritization model. Indeed, the dynamic provider prioritizing system 106 can generate a negation element 632 selectable to continue participating in the requester selected network characteristics prioritization model. In addition, the dynamic provider prioritizing system 106 can generate a confirmation element 634 selectable to opt out of participating in the requester selected network characteristics prioritization model.

Thus, the dynamic provider prioritizing system 106 can implement a first model (in locations with third-party prioritization models in place) that provides an increased transportation value (e.g., 5% bonus per ride) and prioritized matching (e.g., 10% more rides via dispatch boost) for providers hitting certain eligibility criteria (e.g., threshold smooth cruiser score, threshold risk flags, threshold acceptance rate, and/or threshold cancel rate). The dynamic provider prioritizing system 106 can also implement a second model (in locations without third-party prioritization models in place) that provides prioritize matching (e.g., 10-15% more rides via dispatch boost). This second model can also include a different implementation framework that allows requester client devices to opt-in to select the dynamic characteristics of matched provider devices. For instance, the dynamic provider prioritizing system 106 can provide an opt-in element to requester client devices that allows requesters to prioritize driver devices that satisfy risk and reliability criteria. Thus, the first model discussed above can be implemented as a self-executing prioritization framework, whereas the second model discussed above can be implemented as a requester-driven framework that generates prioritized transportation matches according to provider devices aligning to dynamic, real-time metrics preferred by requester client devices.

In one or more embodiments, each of the components of the dynamic provider prioritizing system 106 are in communication with one another using any suitable communication technologies. Additionally, the components of the dynamic provider prioritizing system 106 can be in communication with one or more other devices including one or more client devices described above. Furthermore, although the components of FIGS. 1-6E are described in connection with the dynamic provider prioritizing system 106, at least some of the components for performing operations in conjunction with the dynamic provider prioritizing system 106 described herein may be implemented on other devices within the environment.

The components of the dynamic provider prioritizing system 106 can include software, hardware, or both. For example, the components of the dynamic provider prioritizing system 106 can include one or more instructions stored on a computer-readable storage medium and executable by processors of one or more computing devices. When executed by the one or more processors, the computer-executable instructions of the dynamic provider prioritizing system 106 can cause the computing device to perform the methods described herein. Alternatively, the components of the dynamic provider prioritizing system 106 can comprise hardware, such as a special purpose processing device to perform a certain function or group of functions. Additionally or alternatively, the components of the dynamic provider prioritizing system 106 can include a combination of computer-executable instructions and hardware.

Furthermore, the components of the dynamic provider prioritizing system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the dynamic provider prioritizing system 106 may be implemented as part of a stand-alone application on a personal computing device or a mobile device. Alternatively or additionally, the components of the dynamic provider prioritizing system 106 may be implemented in any application that allows creation and delivery of marketing content to users, including, but not limited to, various applications.

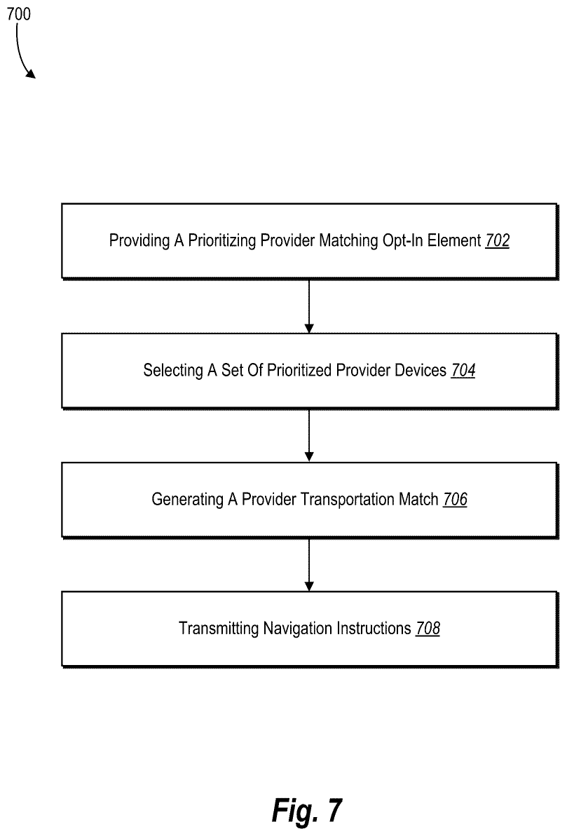

FIGS. 1-6E, the corresponding text, and the examples provide a number of different systems, methods, and non-transitory computer readable media for identifying contextual characteristics of requesters and/or providers and providing contextual transportation matches between requester client devices and provider devices associated with respective requesters and providers sharing identified contextual characteristics. In addition to the foregoing, embodiments can also be described in terms of flowcharts comprising acts for accomplishing a particular result. For example, FIG. 7 illustrates a flowchart of an example sequence of acts in accordance with one or more embodiments.

While FIG. 7 illustrates acts according to some embodiments, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7. Additionally, the acts described herein may be repeated or performed in parallel with one another or in parallel with different instances of the same or other similar acts.

FIG. 7 illustrates an example series of acts 700 for identifying contextual characteristics of a requester and providing a contextual transportation match to a requester client device associated with the requester in accordance with one or more embodiments. As shown, the series of acts 700 includes an act 702 of providing a prioritizing provider matching opt-in element, an act 704 of selecting a set of prioritized provider devices, an act 706 of generating a provider transportation match, and an act 708 of transmitting navigation instructions.

For example, in one or more implementations, the acts 702-708 include: providing, in a user interface of a requester client device, a prioritizing provider matching opt-in element corresponding to dynamic provider network status characteristics; selecting a set of prioritized provider devices by: monitoring dynamic provider network status characteristics of a plurality of provider devices; and comparing the dynamic provider network status characteristics to a plurality of network status thresholds; generating, in response to receiving a transportation request and based on detecting an interaction with the prioritizing provider matching opt-in element, a provider transportation match between the requester client device and a prioritized provider device of the set of prioritized provider devices; and transmitting navigation instructions to a provider device associated with the prioritized provider.

Additionally, in one or more embodiments, the series of acts 700 can include monitoring the plurality of provider devices to determine risk signals and provider network interactions associated with each provider device. Indeed, the series of acts 700 can include comparing the risk signals and provider network interactions of each provider device to the plurality of network status thresholds and selecting the set of prioritized provider devices by identifying a subset of the plurality of provider devices with risk signals and provider network interactions that satisfy the plurality of network status thresholds.

In addition, in one or more embodiments, the series of acts 700 can include identifying telematics data associated with each provider device of the plurality of provider devices. Indeed, the series of acts 700 can include comparing the risk signals to the plurality of network status thresholds by comparing the telematics data for each provider device to a corresponding subset of the plurality of network status thresholds.

Moreover, in some embodiments, the series of acts 700 can include selecting a provider prioritization model from among a set of provider prioritization models, wherein each provider prioritization model of the set of provider prioritization models corresponds to a geographic location. Indeed, the series of acts 700 can include selecting the set of prioritized provider devices according to the provider prioritization model.

Additionally, in one or more embodiments, the series of acts 700 can include determining, from global positioning system data associated with a second set of prioritized provider devices, that the second set of prioritized provider devices are located in a first geographic location. Indeed, the series of acts 700 can include based on determining that the second set of prioritized provider devices are located in the first geographic location, selecting a self-executing provider prioritization model from the set of provider prioritization models.

Furthermore, in some embodiments, the series of acts 700 can include, based on selecting the set of prioritized provider devices, applying a transportation value modifier to each prioritized provider device of the second set of prioritized provider devices.

In addition, in one or more embodiments, the series of acts 700 can include determining, from global positioning system data associated with a set of provider devices, that a set of provider devices are located in a second geographic location. Indeed, the series of acts 700 can include, based on determining that the set of provider devices are located in the second geographic location, selecting a requester selected network characteristics prioritization model from the set of provider prioritization models.

Moreover, in some embodiments, the series of acts 700 can include, based on selecting the requester selected network characteristics prioritization model, providing, for display on the user interface of the requester client device, the prioritizing provider matching opt-in element.

Additionally, in one or more embodiments, the series of acts 700 can include, based on determining an indication of an interaction from the requester client device with the prioritizing provider matching opt-in element, comparing dynamic provider network status characteristics associated with the plurality of provider devices to the plurality of network status thresholds to determine that a subset of the plurality of provider devices are the set of prioritized provider devices.

Additionally, in some embodiments, the series of acts 700 can include determining, from global positioning system data associated with a set of provider devices, that a set of provider devices are located in a first geographic location. Indeed, the series of acts 700 can include, based on determining that the set of provider devices are located in the first geographic location, selecting a requester selected network characteristics prioritization model from the set of provider prioritization models.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 (e.g., the provider device(s) 122, the requester client device(s) 112, or the server(s) 102) that may be configured to perform one or more of the processes described above. One will appreciate that the dynamic provider prioritizing system 106 can comprise implementations of the computing device 800, including, but not limited to, the provider device(s) 122 and/or the server(s) 102. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output interface 808 (or “I/O interface 808”), which are provided to allow a user (e.g., requester or provider) to provide input to (such as user strokes), receive output from, and otherwise transfer data to and from the computing device 800. The I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that connects components of computing device 800 to each other.

FIG. 9 illustrates an example network environment 900 of the transportation matching system 104. The network environment 900 includes a client device 906 (e.g., the provider device(s) 122 or the requester client device(s) 112), a transportation matching system 104, and a vehicle subsystem 908 connected to each other by a network 904. Although FIG. 9 illustrates a particular arrangement of the client device 906, the transportation matching system 104, the vehicle subsystem 908, and the network 904, this disclosure contemplates any suitable arrangement of client device 906, the transportation matching system 104, the vehicle subsystem 908, and the network 904. As an example, and not by way of limitation, two or more of client device 906, the transportation matching system 104, and the vehicle subsystem 908 communicate directly, bypassing network 904. As another example, two or more of client device 906, the transportation matching system 104, and the vehicle subsystem 908 may be physically or logically co-located with each other in whole or in part.

Moreover, although FIG. 9 illustrates a particular number of client devices 906, transportation matching systems 104, vehicle subsystems 908, and networks 904, this disclosure contemplates any suitable number of client devices 906, transportation matching system 104, vehicle subsystems 908, and networks 904. As an example, and not by way of limitation, network environment 900 may include multiple client devices 906, transportation matching system 104, vehicle subsystems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, dynamic provider prioritizing system 106, and vehicle subsystem 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 104. In addition, the transportation matching system 104 may manage identities of service requesters such as users/requesters. In particular, the transportation matching system 104 may maintain requester data such as driving/riding histories, personal data, or other user data in addition to navigation and/or traffic management services or other location services (e.g., GPS services).

In particular embodiments, the transportation matching system 104 may manage transportation matching services to connect a user/requester with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 900 either directly or via network 904. In particular embodiments, the transportation matching system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 904.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 906. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 906 associated with users.

In addition, the vehicle subsystem 908 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 908 can include an autonomous vehicle—e.g., a vehicle that does not require a human operator. In these embodiments, the vehicle subsystem 908 can perform maneuvers, communicate, and otherwise function without the aid of a human provider, in accordance with available technology.

In particular embodiments, the vehicle subsystem 908 may include one or more sensors incorporated therein or associated thereto. For example, sensor(s) can be mounted on the top of the vehicle subsystem 908 or else can be located within the interior of the vehicle subsystem 908. In certain embodiments, the sensor(s) can be located in multiple areas at once—e.g., split up throughout the vehicle subsystem 908 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 908 may include a communication device capable of communicating with the client device 906 and/or the dynamic provider prioritizing system 106. For example, the vehicle subsystem 908 can include an on-board computing device communicatively linked to the network 904 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method, comprising:
providing, in a user interface of a requester client device, a prioritizing provider matching opt-in element corresponding to dynamic provider network status characteristics;
selecting a set of prioritized provider devices by:
monitoring the dynamic provider network status characteristics for a plurality of provider devices; and
comparing the dynamic provider network status characteristics to a plurality of network status thresholds;
generating, in response to receiving a transportation request and based on detecting an interaction with the prioritizing provider matching opt-in element, a provider transportation match between the requester client device and a prioritized provider device of the set of prioritized provider devices; and
transmitting navigation instructions to a provider device associated with the prioritized provider device.

2. The method of claim 1, further comprising:
monitoring the plurality of provider devices to determine risk signals and provider network interactions associated with each provider device; and
comparing the risk signals and provider network interactions of each provider device to the plurality of network status thresholds and selecting the set of prioritized provider devices by identifying a subset of the plurality of provider devices with risk signals and provider network interactions that satisfy the plurality of network status thresholds.

3. The method of claim 2, further comprising:
identifying telematics data associated with each provider device of the plurality of provider devices; and
comparing the risk signals to the plurality of network status thresholds by comparing the telematics data for each provider device to a corresponding subset of the plurality of network status thresholds.

4. The method of claim 1, further comprising:
selecting a provider prioritization model from among a set of provider prioritization models, wherein each provider prioritization model of the set of provider prioritization models corresponds to a geographic location; and
selecting the set of prioritized provider devices according to the provider prioritization model.

5. The method of claim 4, further comprising:
determining, from global positioning system data associated with a second set of prioritized provider devices, that the second set of prioritized provider devices are located in a first geographic location; and
based on determining that the second set of prioritized provider devices are located in the first geographic location, selecting a self-executing provider prioritization model from the set of provider prioritization models.

6. The method of claim 5, further comprising, based on selecting the set of prioritized provider devices, applying a transportation value modifier to each prioritized provider device of the second set of prioritized provider devices.

7. The method of claim 5, further comprising:
determining, from global positioning system data associated with a set of provider devices, that a set of provider devices are located in a second geographic location; and
based on determining that the set of provider devices are located in the second geographic location, selecting a requester selected network characteristics prioritization model from the set of provider prioritization models.

8. The method of claim 7, further comprising, based on selecting the requester selected network characteristics prioritization model, providing, for display on the user interface of the requester client device, the prioritizing provider matching opt-in element.

9. The method of claim 8, further comprising, based on determining an indication of an interaction from the requester client device with the prioritizing provider matching opt-in element, comparing dynamic provider network status characteristics associated with the plurality of provider devices to the plurality of network status thresholds to determine that a subset of the plurality of provider devices are the set of prioritized provider devices.

10. A system comprising:
at least one processor; and
at least one non-transitory computer-readable storage medium storing instructions that, when executed by the at least one processor, cause the system to:
provide, in a user interface of a requester client device, a prioritizing provider matching opt-in element corresponding to dynamic provider network status characteristics;
select a set of prioritized provider devices by:
monitor the dynamic provider network status characteristics for a plurality of provider devices; and
compare the dynamic provider network status characteristics to a plurality of network status thresholds;
generate, in response to receiving a transportation request and based on detecting an interaction with the prioritizing provider matching opt-in element, a provider transportation match between the requester client device and a prioritized provider device of the set of prioritized provider devices; and
transmit navigation instructions to a provider device associated with the prioritized provider device.

11. The system of claim 10, further comprising instructions that, when executed by the at least one processor, cause the system to:
monitor the plurality of provider devices to determine risk signals and provider network interactions associated with each provider device; and
compare the risk signals and provider network interactions of each provider device to the plurality of network status thresholds and selecting the set of prioritized provider devices by identifying a subset of the plurality of provider devices with risk signals and provider network interactions that satisfy the plurality of network status thresholds.

12. The system of claim 11, further comprising instructions that, when executed by the at least one processor, cause the system to:
identify telematics data associated with each provider device of the plurality of provider devices; and
compare the risk signals to the plurality of network status thresholds by comparing the telematics data for each provider device to a corresponding subset of the plurality of network status thresholds.

13. The system of claim 10, further comprising instructions that, when executed by the at least one processor, cause the system to:
select a provider prioritization model from among a set of provider prioritization models, wherein each provider prioritization model of the set of provider prioritization models corresponds to a geographic location; and
select the set of prioritized provider devices according to the provider prioritization model.

14. The system of claim 13, further comprising instructions that, when executed by the at least one processor, cause the system to:
determine, from global positioning system data associated with a second set of prioritized provider devices, that the second set of prioritized provider devices are located in a first geographic location; and
based on determining that the second set of prioritized provider devices are located in the first geographic location, select a self-executing provider prioritization model from the set of provider prioritization models.

15. The system of claim 14, further comprising instructions that, when executed by the at least one processor, cause the system to, based on selecting the set of prioritized provider devices, apply a transportation value modifier to each prioritized provider device of the second set of prioritized provider devices.

16. A non-transitory computer-readable medium storing instructions thereon that, when executed by at least one processor, cause a computing device to:
provide, in a user interface of a requester client device, a prioritizing provider matching opt-in element corresponding to dynamic provider network status characteristics;
select a set of prioritized provider devices by:
monitoring the dynamic provider network status characteristics for a plurality of provider devices; and
comparing the dynamic provider network status characteristics to a plurality of network status thresholds;
generate, in response to receiving a transportation request and based on detecting an interaction with the prioritizing provider matching opt-in element, a provider transportation match between the requester client device and a prioritized provider device of the set of prioritized provider devices; and
transmit navigation instructions to a provider device associated with the prioritized provider device.

17. The non-transitory computer-readable medium of claim 16, further comprising instructions that, when executed by the at least one processor, cause the computing device to:
select a provider prioritization model from among a set of provider prioritization models, wherein each provider prioritization model of the set of provider prioritization models corresponds to a geographic location; and
select the set of prioritized provider devices according to the provider prioritization model.

18. The non-transitory computer-readable medium of claim 17, further comprising instructions that, when executed by the at least one processor, cause the computing device to:
determine, from global positioning system data associated with a set of provider devices, that a set of provider devices are located in a first geographic location; and
based on determining that the set of provider devices are located in the first geographic location, select a requester selected network characteristics prioritization model from the set of provider prioritization models.

19. The non-transitory computer-readable medium of claim 18, further comprising instructions that, when executed by the at least one processor, cause the computing device to, based on selecting the requester selected network characteristics prioritization model, provide, for display on the user interface of the requester client device, the prioritizing provider matching opt-in element.

20. The non-transitory computer-readable medium of claim 19, further comprising instructions that, when executed by the at least one processor, cause the computing device to, based on determining an indication of an interaction from the requester client device with the prioritizing provider matching opt-in element, compare dynamic provider network status characteristics associated with the plurality of provider devices to the plurality of network status thresholds to determine that a subset of the plurality of provider devices are the set of prioritized provider devices.
